(19) United States
(12) Patent Application Publication
(10) Pub. No.: US 2021/0272034 A1
(43) Pub. Date: Sep. 2, 2021

(54) METHOD OF FRAGMENTATION OF LARGE FILES WITH APPLICATION TO THE PHONE NUMBER DATA UPDATE PROBLEM

(71) Applicant: VIETTEL GROUP, Ha Noi City (VN)

(72) Inventor: Van Chung Trinh, Ha Noi City (VN)

(73) Assignee: VIETTEL GROUP, Ha Noi City (VN)

(21) Appl. No.: 17/119,730

(22) Filed: Dec. 11, 2020

(30) Foreign Application Priority Data
Feb. 28, 2020 (VN) 1-2020- 01147

(51) Int. Cl. G06Q 10/06; G06F 16/17; G06F 16/13; G06F 16/178; G06F 9/52; G06F 16/185

(52) U.S. Cl. CPC G06Q 10/06312; G06F 16/1724; G06F 16/13; G06Q 10/06315; G06F 9/52; G06F 16/185; G06F 16/178

(57) ABSTRACT

The method of fragmentation of large files applied to the problem of updating phone numbers according to the proposed invention helps to solve the problem of increasing the speed of reading/writing/updating/deleting large files, solving solving issues of getting a high load of interactive examination with a data file sized in the millions of records, including the steps: step 1: read the configuration data from the table in the database, save the data structure for processing; step 2 receive the request; step 3: read the file and split the work; step 4: handle concurrent interaction with sub-files.2

### TECHNICAL AREA

The invention refers to the method of fragmentation of large files applied to the problem of updating phone number data for customer interactive campaign systems. The invention is applied in the information technology field.

### THE TECHNICAL STATUS OF THE INVENTION

The most important task of a customer engagement campaign system is to stimulate interactions on a specific set of subscribers. Stimulating interaction includes: creating subscriber campaigns, sending invitations to the right subscribers.

The steps to add new promotions are as follows:

Step 1: the operator creates a promotion;

Step 2: push the file containing the list of phone numbers of the program to the system;

Step 3: The system reads the file containing the phone number list and interacts with each subscriber in the list.

During the implementation of the campaign, it is possible to update, add, modify or delete a list of phone numbers in the original file, this process includes the following steps:

Step 4: The system reads the set of phone numbers that wanted to add, modify, delete;

Step 5: update back to the original file to save the final data;

Step 6: The system interacts with the changed phone number list set.

In particular, step 3 and step 5 of the change process are important steps in the entire process of implementing interactive campaigns. This process is time consuming in steps 3 and 5, so in order to reduce the execution time of the whole process, it is necessary to reduce the processing time to read the file in step 3 and reduce the time to update the file. believe in step 5.

### THE TECHNICAL NATURE OF THE INVENTION

The purpose of the invention is to propose a method of large file fragmentation to be applied to the problem of updating phone number data. The problem solving method involves reading, writing new and updating large data phone number files (millions of records), thereby optimizing the processing time of the entire process.

To achieve the above purpose, the invention proposes a method of fragmentation of large files to be applied to the problem of updating phone number data with specific implementation steps as follows:

Step 1: read the configuration data from the table in the database, save the data structure for processing.

When creating the campaign, the operator needs to define a method to read and write the phone number file. This method will be saved in the data table in the database. When the read-configuration processing (Campaign Cache) is launched, the data table is read and the data structure is saved for processing.

Step 2: receive the request.

When a request to process a file is received from the operator, a Campaign Handler retrieves the campaign identifier in the request, from this information a method to read the file data. information in the data structure is built in step 1.

Step 3: read the file and split the work.

File reading and distribution stream (Campain Read and Distribute) performs access to the original file phone number, reading each phone number. Based on the read and write method obtained in step 2. Convert the write request to parallel processing streams.

Step 4: handle concurrent interaction with sub-files.

Depending on the configuration, it is possible to generate the number of concurrent processing threads corresponding to the number of configurations. Each stream processes a data set of numbers that share a specific characteristic.

This solution is based on the theory of dividing large jobs into many small jobs, from which small jobs can be processed simultaneously, reducing the total processing time.

### BRIEF DESCRIPTION OF THE DRAWINGS

In order for the invention to be described more clearly, the figures below describe parts of the invention:

FIG. 1 shows a diagram showing the flow of new files and concurrent processing;

FIG. 2 is a drawing of the flow model of adding new files and handling data update/deletion;

FIG. 3 shows a three-level nested data structure used; and

FIG. 4 shows a drawing of the method that the invention proposes.

### DETAILED DESCRIPTION

In a customer interaction campaign implementation system, the main task is to increase interactions with a large set of customers in the shortest amount of time. Therefore, the optimization of the processing speed is the first priority.

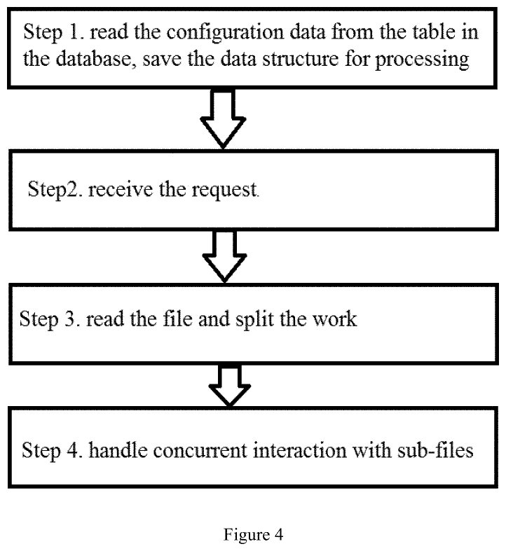

The method of large file fragmentation applied to the phone number data update problem helps to optimize the time to read and write phone number data. Modules to execute the program are launched on the system including 03 servers, servers connected to each other via the internal network, servers respectively SV01, SV02, SV03. Referring to FIG. 4, the proposed methodology including the sequential steps is outlined below:

Step 1: read the configuration data from the table in the database, save the data structure for processing.

When declaring a customer interaction campaign program, define read and write methods when there is a request to read/write/update the phone number file.

Read/write methods are understood as specific rules for splitting original files into smaller files. The rules stored on the table specify the file division rule, and the table has the following structure:

| Name | Type | Meaning |
|---|---|---|
| RULE_ID | Integer | The table's primary key, which is of the |
| | | integer data type |
| CAMPAIGNED | Integer | Campaign identifier |
| EXPRESSION | Integer | Describes the conditions for splitting files |
| DESCRIPTION | String | Description for additional information |

After having a rule, the data table specifies a list of child files to be populated, describing the file name when it is split.

| Name | Type | Meaning |
|---|---|---|
| ID | Integer | The table's primary key, which is of |
| | | the integer data type |
| RULE_ID | Integer | Foreign key, associated with the Rule |
| | | table |
| PARENTFILENAME | Integer | The original file name is imported |
| CHILDFILENAME | String | Subdirectory is extracted |
| DESCRIPTION | String | Description for additional information |

The Campaign Cache Module performs database access and retrieves information from two tables specifying file division rules and a table specifying subdirectory based on how base is interacting. the data is available on the database, this method allows the Campaign Cache module to interact with the database. Campaign Cache Module is launched on SV01 server.

After retrieving the data, the information is stored on the data structure of the program, using two data structures simultaneously: data structure “key—synchronous content” (ConcurrentHashMap) and data structure in the form of a list (Array List).

Array List is used to store a list of sub-files contained in a table data table specifying a list of sub-files with the same value in the RULE_ID field. Each record is represented by an object with the following properties: FILE {RULE_ID, CHILDFILENAME, DESCRIPTION}

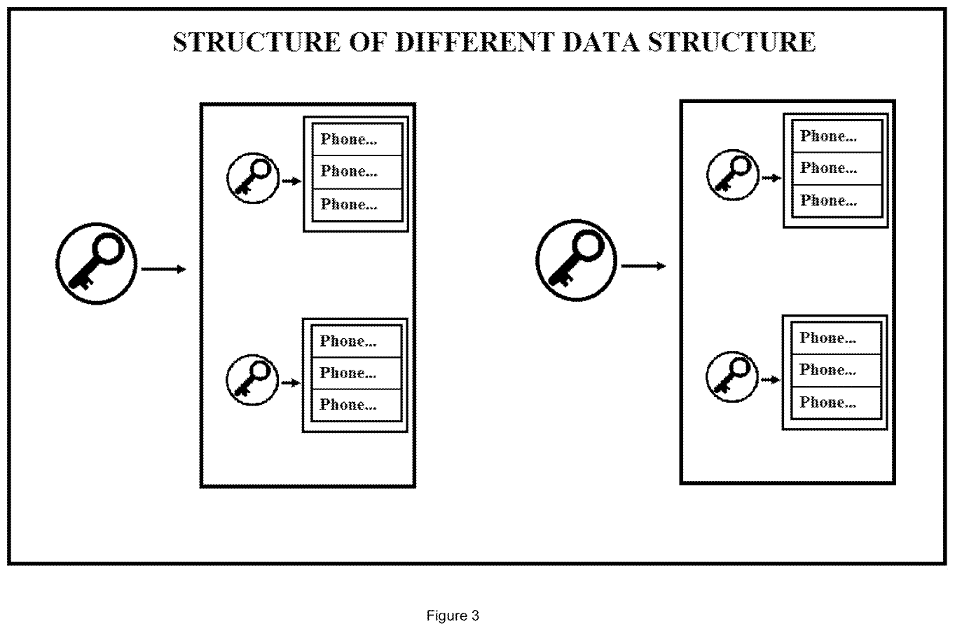

Referring to FIG. 3, the data structure “lock—synchronized content” uses two layers:

The inner class is used to describe how many sub-files an initial file can contain. In this data structure, the key is obtained from the PARENTFILENAME information, or the filename was originally imported, the content is a list data structure consisting of the set of objects with this same value.

The outermost layer is used to describe how many parent files a campaign has, and how many children there are in each parent file. In this data structure, the key is obtained from the campaign identifier (the CAMPAIGN_IDfield according to the file division rules table), the content is a set of synchronized key-content data structures of the side layer in.

At the end of the process, the output is a two-layer synchronized key-content data structure, inside the list data structure saved. Information includes list of campaigns, set of parent files of each campaign, set of child files of each parent file.

Step 2: receive the request.

The Campaign Handler Module receives request information to read/write/update data from external file. The request message contains the campaign identifier and the path to the file containing a list of phone numbers. The Campaign Handler module is launched on the SV02 server.

The processing thread gets the path information to the file in the request, the built-in method supports the file retrieval used with the input parameter as the file path.

Step 3: read the file and split the work.

The Campain Read and Distribute Module performs access to the original file phone numbers, reading each phone number, based on the read and write method obtained in step 2. Campain Read and Distribute Module is started on SV03 server. Convert the write request to parallel processing streams.

After accessing the input file, using the file reading method supported by the programming language, reading each line of the file, each line of the file is a phone number.

The processing stream takes campaign identifier information, put the obtained phone number to find the key in the key data structure—two-layer synchronized content, thereby finding a method of splitting files in the condition attribute of the object, the number of the sub-files and the location of the sub-files.

The File splitting method is understood as a rule, putting the phone number contained in the original file into one of the sub files.

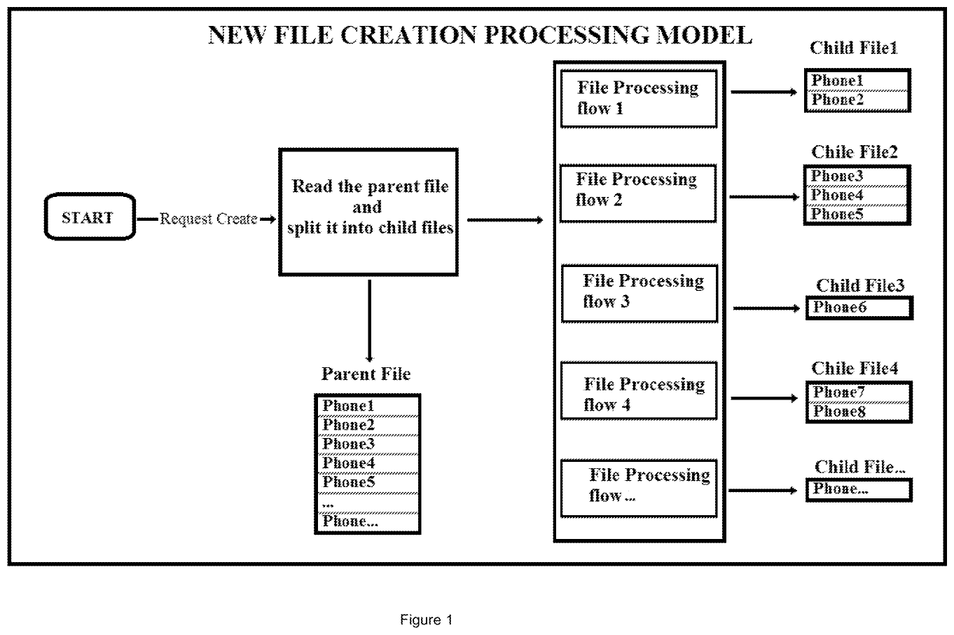

Refer to FIG. 1, if the input request is to add new data, the phone number will be written to a sub-file and the system performs the customer interaction operation.

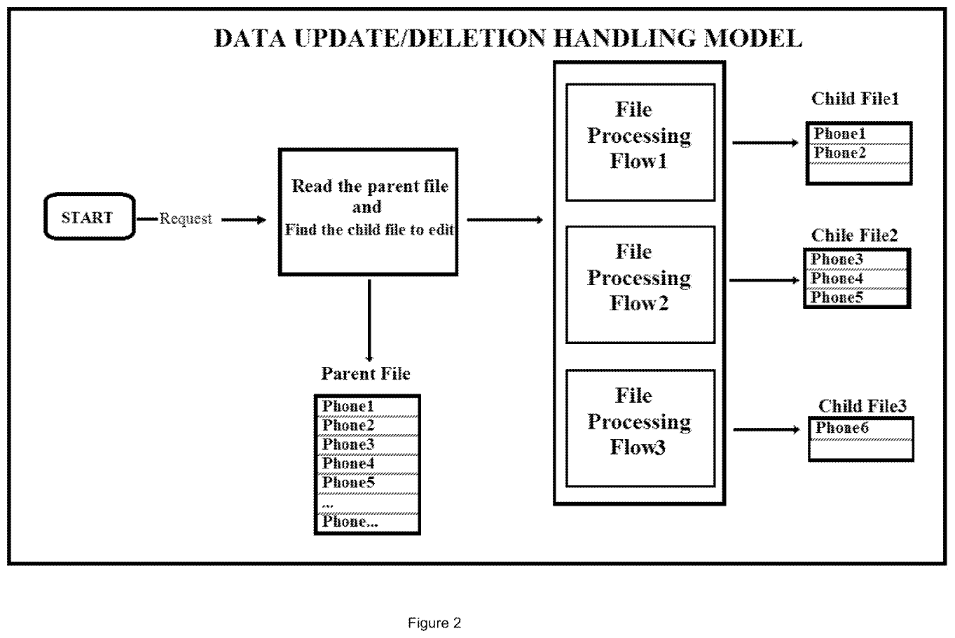

Referring to FIG. 2, if the input request is update or delete, the thread searches for a sub-file containing the phone number to perform the update or delete job.

After finding the appropriate thread for the phone number, send a request to the corresponding processor to continue.

Step 4: handle concurrent interaction with sub-files.

Sub-file processing threads are understood as concurrent processing threads, applying the operating system's multithreading mechanism (Multi Thread).

Each child process processes a sub-file, and due to the simultaneous processing, the speed will be almost linear according to the number of sub-processes.

When the request is done executing, the child processes end their own lives to offload the server and wait for the next request to continue processing.

### EFFECTIVENESS OF THE INVENTION

This solution helps to solve the problem of increasing the speed of reading/writing/updating/deleting large files, solving the problem of high load interaction with a file with data size of millions of records.

What is claimed is:

1. The method of large file fragmentation applied to the phone number data update problem comprising the steps of:
step 1: when declaring a customer interaction campaign program, define read and write methods when there is a request to read, write, update a phone number file, read, write methods are understood as specific rules for splitting original files into smaller files, after retrieving the data, the information is stored on a data structure, using two data structures simultaneously, a data structure key—synchronous content and a data structure in the form of a list, it is used to store a list of sub-files contained in a table data table specifying a list of sub-files with a same value in a RULE_ID field; Each record is represented by an object with the following properties FILE {RULE_ID, CHILDFILENAME, DESCRIPTION};
step 2: a campaign handler module receives request information to read, write, update data from an external file, the request information contains a campaign identifier and a path to a file containing a list of phone numbers;
step 3: a campaign read and distribute module performs access to an original file phone number, reading each phone number, based on the read and write method obtained in step 2, convert the write request to parallel processing streams, the processing streams take campaign identifier information, put the obtained phone number to find a key in a key data structure two layer synchronized content, thereby finding a method of splitting files into a condition attribute of the object, a number of the sub files and a location of the sub files;
step 4: concurrent sub file processing threads, applying an operating system's multithreading mechanism, each child process processes a sub file, and due to the simultaneous processing, the speed will be almost linear according to the number of sub processes.

2. The method of large file fragmentation applied to the phone number data update problem according to claim 1, in which:
In step 1, after having a rule, the data table specifies a list of child files to be populated, describing the file name when it is split.

3. The method of large file fragmentation applied to the phone number data update problem according to claim 1, in which:
In step 1, a campaign cache module performs database access and retrieves information from two tables specifying file division rules and a table specifying subdirectory based on how database is interacting, with the data is available on the database.

4. The method of large file fragmentation applied to the phone number data update problem according to claim 1, in which:
In step 1, a data structure “lock—synchronized content” is used with two layers.

5. The method of large file fragmentation applied to the phone number data update problem according to claim 1, in which:
In step 1, an inner class is used to describe how many sub-files an initial file can contain.

6. The method of large file fragmentation applied to the phone number data update problem according to claim 1, in which:
In step 1, in the data structure, the data structure key is obtained from the TEN_TEP_TIN_CHA information, or the filename was originally imported, the content is a list data structure consisting of the set of objects with this same value.

7. The method of large file fragmentation applied to the phone number data update problem according to claim 1, in which:
In step 1, an outermost layer is used to describe how many parent files a campaign has, and how many children there are in each parent file.

8. The method of large file fragmentation applied to the phone number data update problem according to claim 1, in which:
In step 1, in the data structure, the key is obtained from the campaign identifier (the IDCHIENDICH field according to the file division rules table), the content is a set of synchronized key-content data structures of the side layer in.

9. The method of large file fragmentation applied to the phone number data update problem according to claim 1, in which:
In step 1, at the end of the process, the output is a two-layer synchronized key-content data structure, inside the list data structure saved.

10. The method of large file fragmentation applied to the phone number data update problem according to claim 1, in which:
In step 1, information includes list of campaigns, set of parent files of each campaign, set of child files of each parent file.

11. The method of large file fragmentation applied to the phone number data update problem according to claim 1, in which:
In step 2, the processing thread gets a path information to the file in the request, the built in method supports the file retrieval used with the input parameter as the file path.

12. The method of large file fragmentation applied to the phone number data update problem according to claim 1, in which:
In step 3, after accessing the input file, using the file reading method supported by the programming language, reading each line of the file, each line of the file is a phone number.

13. The method of large file fragmentation applied to the phone number data update problem according to claim 1, in which:
In step 3, file splitting method is understood as a rule, putting the phone number contained in the original file into one of the sub files.

14. The method of large file fragmentation applied to the phone number data update problem according to claim 1, in which:
In step 3, if the input request is to add new data, the phone number will be written to a sub-file and the system performs the customer interaction operation.

15. The method of large file fragmentation applied to the phone number data update problem according to claim 1, in which:
In step 3, if the input request is update or delete, the thread searches for a sub-file containing the phone number to perform the update or delete job.

16. The method of large file fragmentation applied to the phone number data update problem according to claim 1, in which:
In step 3, after finding the appropriate thread for the phone number, sending a request to the corresponding processor to continue.

17. The method of large file fragmentation applied to the phone number data update problem according to claim 1, in which:
In step 4, when the request is done executing, the child processes end their own lives to offload the server and wait for the next request to continue processing.
